(19) United States
(12) Patent Application Publication
(10) Pub. No.: US 2008/0111114 A1
(43) Pub. Date: May 15, 2008

(54) FLAME-RETARDANT MATERIALS AND SYSTEMS

(76) Inventor: Alan M. Gilbert, Mckinney, TX (US)

Correspondence Address: STORM LLP, BANK OF AMERICA PLAZA, 901 MAIN STREET, SUITE 7100, DALLAS, TX, 75202, US

(21) Appl. No.: 11/929,670

(22) Filed: Oct. 30, 2007

Related U.S. Application Data
(60) Provisional application No. 60/855,340, filed on Oct. 30, 2006.

(51) Int. Cl. C09K 21/14

(52) U.S. Cl. 252/605; 252/601

(57) ABSTRACT

A flame-retardant composition comprises a nanocube or metal organic framework having a plurality of porosities formed therein; a flame retardant material occupying the porosities; and a matrix material in which said nanocubes are dispersed. The flame retardant may further comprise a sealant applied to at least a portion of the nanocube, wherein the sealant substantially prevents the gas from escaping the porosities in the nanocube. It may also include a composition wherein the matrix is a flame-retardant composition adapted to be applied to fabric. The invention may also include nanocubes formed of a material that will break down and release the gas in the presence of water or nanocubes formed of a material that will break down and release the gas in the presence of flame. The nanocubes containing the flame retardant material may also be sealed with a sealant that is a polymer material.

### RELATED APPLICATIONS

This application claims priority to provisional application Ser. No. 60/855,340, filed Oct. 30, 2006 by Alan GILBERT And Entitled FLAME-RETARDANT MATERIALS AND SYSTEMS

### TECHNICAL FIELD

The invention relates generally to flame-retardant materials and, more particularly, to the use of nanocubes to store flame-retardant, non-flammable, or oxygen displacing gases, which are applied to or stored in various materials.

### SUMMARY OF THE INVENTION

The invention includes a flame-retardant composition comprising a nanocube or metal organic framework having a plurality of porosities formed therein; a flame retardant material occupying the porosities; and a matrix material in which said nanocubes are dispersed. The flame retardant may further comprise a sealant applied to at least a portion of the nanocube, wherein the sealant substantially prevents the gas from escaping the porosities in the nanocube. It may also include a composition wherein the matrix is a flame-retardant composition adapted to be applied to fabric. The invention may also include nanocubes formed of a material that will break down and release the gas in the presence of water or nanocubes formed of a material that will break down and release the gas in the presence of flame. The nanocubes containing the flame retardant material may also be sealed with a sealant that is a polymer material.

Another aspect of the invention includes a flame-retardant composition comprising a nanocube having a plurality of porosities formed therein; an inflammable, oxygen-displacing gas occupying the porosities; and a sealant applied to at least a portion of the nanocube, wherein the sealant substantially prevents the gas from escaping the porosities in the nanocube. This embodiment may also include a matrix that is a polymer material. This composition may include a matrix that is a flame-retardant composition adapted to be applied to fabric. This composition may include nanocubes that are formed of a material that will break down and release the gas in the presence of water or nanocubes formed of a material that will break down and release the gas in the presence of flame.

### DETAILED DESCRIPTION

A number of unique substances known as nanocubes were discovered and studied at various universities around the United States. These nanocubes are of a family of organometallic (typically called metal organic frameworks or MOFs) materials that are highly crystalline, porous materials, having more free volume than most zeolites. The chemical functionality of the pores of these nanocubes or MOFs can be varied for used in storage or encapsulation of gasses; thus allowing for an enormous storage capacity. One proposed stored gas is hydrogen for use as a fuel cell. One method of producing such nanocubes or MOFs is found in U.S. Pat. No. 7,119,219, Oct. 10, 2006 to Mueller, et al. Other methods and resulting MOF structures can be found in U.S. Pat. Nos. 7,196,210; 6,930,193; and 5,648,508, all to Yaghi, et al.

An example of such an existing nanocube is an isoreticular MOF that employs zinc-oxygen clusters (Zn₄O), which are a tetrahedral clusters with the oxygen atom at the center of the tetrahedron, interconnected with benzene ring struts. Some of the benzene ring struts used have been 1, 4-benzenedicarboxylate and a cyclobutyl-benzene strut. Namely, the cyclobutyl-benzene MOF has been used to encapsulate methane.

However, even with the advances in MOF or nanocube technology, applications for these substances is relatively limited. Moreover, the number of MOF substances remains relatively small (numbering less than 500). The preferred embodiment of the present invention, though, is directed toward an application of these MOFs or nanocubes, namely their use with fire retardant compounds contained within them.

As with previously known nanocubes, the MOFs for use in flame-retardant applications include zinc-oxygen (OZn₄) clusters having benzene ring struts. The preferred MOF is known as MOF-177. MOF-177 is known to absorb up to 140 times its weight in gas, such as carbon dioxide (CO2), at pressures between about 32 and 36 bar.

This and similar nanocubes or MOFs can be employed to contain or encapsulate or otherwise contain an oxygen displacing, non-flammable, or fire retardant gas, such as diatomic nitrogen, carbon dioxide, or argon. The gas is encapsulated by exposure of the MOF material to the gas at elevated pressure. In the case of MOF-177 and CO2 a quantity of MOF particles are exposed to CO2 at elevated pressure, preferably between 32 and 36 bar.

Once the gas is contained or encapsulated within the MOF, the flame-retardant nanocubes or MOFs may be sealed, preferably with a gas-impermeable polymer such as that disclosed in United States Patent Publication 2006-0229402, which is incorporated herein by reference.

The sealed nanocubes or MOFs may optionally be combined into a matrix, also preferably a polymer material, such as polyethylene, polyurethane, polystyrene, or the like. The matrix is, thus, of sufficient size so as to be applied to materials in fire retardant applications. The sealant and matrix also can be varied so as to release the encapsulated gas under different conditions, such as the application of heat or water. In some instances, the matrix itself performs as the sealer, for example, the gas-filled nanocubes or MOFs are dispersed in a polymer in the molten state, the polymer then being formed into an object that has flame-retardant properties.

An example of a flame-retardant application is a flame-retardant fabric. Specifically, a heat-reactive matrix containing sealed, gas-containing MOFs, is applied to a fabric so that when the fabric reaches a desired temperature, the gas is released to extinguish or suppress the nearby flame.

Another example of a flame-retardant application is a flame-retardant paint. Under these conditions, the binder of the paint operates as the matrix. Thus, when the paint reaches a desired temperature, the gas is released to extinguish or suppress the nearby flame.

Yet another example of a flame-retardant application is a flame-retardant foam. In this application, the foam operates as the matrix for containing the sealed nanocubes. This foam can be a hardening foam (like polystyrene or polyurethane) operating primarily as an insulation or cushioning material or a semi-liquid or liquid form that can be dispersed onto fires.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

I claim:

1. A flame-retardant composition comprising:
a nanocube having a plurality of porosities formed therein;
a flame retardant material occupying the porosities;
and a matrix material in which said nanocubes are dispersed.

2. The composition according to claim 1, further comprising a sealant applied to at least a portion of the nanocube, wherein the sealant substantially prevents the gas from escaping the porosities in the nanocube.

3. The composition according to claim 1, wherein the matrix is a flame-retardant composition adapted to be applied to fabric.

4. The composition according to claim 1, wherein at least one of the matrix and the nanocube is formed of a material that will break down and release the gas in the presence of water.

5. The composition according to claim 1, wherein at least one of the matrix and the nanocube is formed of a material that will break down and release the gas in the presence of flame.

6. The composition according to claim 1, further comprising a sealant which is a polymer material.

7. A flame-retardant composition comprising:
a nanocube having a plurality of porosities formed therein;
an inflammable, oxygen-displacing gas occupying the porosities; and
a sealant applied to at least a portion of the nanocube, wherein the sealant substantially prevents the gas from escaping the porosities in the nanocube.

8. The composition according to claim 7, wherein the matrix is a polymer material.

9. The composition according to claim 7, wherein the matrix is a flame-retardant composition adapted to be applied to fabric.

10. The composition according to claim 7, wherein at least one of the matrix and the nanocube and the sealant is formed of a material that will break down and release the gas in the presence of water.

11. The composition according to claim 7, wherein at least one of the matrix and the nanocube and the sealant is formed of a material that will break down and release the gas in the presence of flame.
